(19) United States
(12) Patent Application Publication
(10) Pub. No.: US 2025/0094763 A1
(43) Pub. Date: Mar. 20, 2025

(54) BRAIN-ON-A-CHIP INTELLIGENCE COMPLEX CONTROL SYSTEM AND CONSTRUCTION AND TRAINING METHOD THEREOF

(71) Applicants: Tianjin University, Tianjin (CN); Southern Universityof Science and Technology, Shenzhen City (CN)

(72) Inventors: Xiaohong LI, Tianjin (CN); Jianguo ZHANG, Shenzhen City (CN); Wenwei SHAO, Tianjin (CN); Quanying LIU, Shenzhen City (CN); Qi SHAO, Tianjin (CN); Guiping CAO, Shenzhen City (CN); Zhichao LIANG, Shenzhen City (CN); Weiwei MENG, Tianjin (CN); Runpeng HOU, Shenzhen City (CN)

(73) Assignees: Tianjin University, Tianjin (CN); Southern Universityof Science and Technology, Shenzhen City (CN)

(21) Appl. No.: 18/579,876

(22) PCT Filed: Dec. 19, 2023
(86) PCT No.: PCT/CN2023/139861

§ 371 Date: Jan. 17, 2024

(30) Foreign Application Priority Data
Aug. 18, 2023 (CN) 2023110464232

(51) Int. Cl. G06N 3/00; G06N 3/092

(52) U.S. Cl. CPC G06N 3/002; G06N 3/092

(57) ABSTRACT

Disclosed is a brain-on-a-chip intelligence complex control system comprising a basic module and an information interaction and training module. The latter integrates a neural signal decoding unit, reward and punishment control unit, task control model, and mapping relationship model. The neural signal decoding unit transforms neural response data into external device-recognizable control instructions. Employed for controlling the external device, the task control model creates a future target control instruction based on task feedback, retrieving the corresponding neural response. The mapping relationship model establishes connections between the brain-on-a-chip's stimulation sequence and neural responses. Calculating task completion, the reward and punishment control unit generates a reward or punishment signal based on task feedback, applying it to the brain-on-a-chip basic module. This innovative brain-on-a-chip intelligence complex enhances control and training capabilities through integrated modules.

### TECHNICAL FIELD

The present invention relates to the field of artificial intelligence control technologies, and more particularly, to a brain-on-a-chip intelligence complex control system and a construction and training method thereof.

### BACKGROUND ART

A brain-on-a-chip intelligence complex is a fusion of biotechnology and information technology, and integrates biological intelligence and machine intelligence, realizing information interaction and full interconnection. A brain-on-a-chip refers to coupling cortical or hippocampal neurons and a cerebral organ with electrodes to construct 2D and 3D neurons, i.e., an electronic complex, and to obtain a “brain-on-a-chip” electronic complex with certain intelligence through external neuromodulation and learning training. With the help of a micro electrode arrays (MEAs) technology, electrophysiological activities of a plurality of sites can be recorded and stimulated at the same time for a non-invasive and long-term time, and the characteristics of neuronal network development and discharge patterns under external stimulations are studied and summarized at the mesoscopic scale, which provides a new perspective for exploring the learning and memory mechanisms of the nervous system and improves the interpretability of biological intelligence. Therefore, an information interaction platform for the brain-on-a-chip intelligence complex is constructed based on MEAs, which can realize real-time recording and feedback of cell culture and neural signals.

The construction of the information interaction platform for the brain-on-a-chip intelligence complex is a necessary condition and an important experimental tool for the construction of the brain-on-a-chip intelligence complex. Previous studies have realized that a 2D neuronal network controls an external device to complete a task in a virtual or real environment, and to characterize biological intelligence through closed-loop feedback information interaction. Due to the independent control of the two environments, there are problems such as high delay time and poor control effect. In addition, as a complex nonlinear system, a neural response of the brain-on-a-chip is a highly dynamic and variable characteristic, so it is difficult to form a stable output mapping relationship of evoked response. The present invention proposes an efficient, controllable and flexible closed-loop control system for information interaction of a brain-on-a-chip intelligence complex, which can realize a learning and training process of the brain-on-a-chip in a virtual environment, and intelligently control an external device to implement a closed-loop control agent task of dual-environment fusion. Meanwhile, this system is fused with a deep learning optimization control module, so that a neuron-evoked response reaches an expected value, is thus autonomous and controllable, and reduces the training cost.

### SUMMARY

An object of the present invention is to overcome the defects of the prior art, and provide a brain-on-a-chip intelligence complex control system and a construction and training method thereof.

The present invention is implemented by the following technical solution.

A brain-on-a-chip intelligence complex control system includes a brain-on-a-chip basic module and a brain-on-a-chip information interaction and training module, wherein
the brain-on-a-chip basic module includes a brain-on-a-chip, and is capable of applying a stimulation to neurons of the brain-on-a-chip and acquiring neural response signals of the brain-on-a-chip;
the brain-on-a-chip information interaction and training module includes a data preprocessing unit, a neural signal decoding unit, a reward and punishment control unit, a task control model and a mapping relationship model;
the data preprocessing unit is configured to process the acquired original neural response signals of the brain-on-a-chip, and extract effective spike signals as neural response data;
the neural signal decoding unit is configured to map the preprocessed neural response data and convert the neural response data into control instructions recognizable by an external device;
the task control model is used for a control task of the external device, and is capable of generating a target control instruction for a next time according to task feedback information, and the task control model is integrated with a correspondence relationship between the neural response data and the control instructions, and is able to obtain a neural response corresponding to the target control instruction according to the correspondence relationship;
the mapping relationship model is configured to construct a mapping relationship between a stimulation sequence of the brain-on-a-chip and the neural response; and
the reward and punishment control unit is configured to calculate a completion degree of the target control instruction to execute a task according to the task feedback information, to generate a reward signal or a punishment signal to the brain-on-a-chip, and apply the signal to the brain-on-a-chip basic module.

In the above technical solution, the brain-on-a-chip basic module includes the brain-on-a-chip, a data acquisition unit and a stimulation unit, wherein the brain-on-a-chip is a coupling body of neurons and an MEAs chip; the data acquisition unit is configured to read neural response signals of the brain-on-a-chip in real time; and the stimulation unit is configured to apply a corresponding stimulation to the neurons of the brain-on-a-chip according to the stimulation sequence of the brain-on-a-chip information interaction and training module.

A construction and training method of the brain-on-a-chip intelligence complex control system includes the following steps:
step 1, making and culturing a mature brain-on-a-chip;
step 2, conducting a pre-experiment to determine stimulation input electrode sites and stimulation response electrode sites of the brain-on-a-chip;
step 3, obtaining a mapping relationship model between a stimulation sequence and a neural response by training;
step 4, constructing a correspondence relationship between neural response data and control instructions for an external device, and embedding the correspondence relationship into a neural signal decoding unit to enable the neural signal decoding unit to convert the neural response data into the control instructions for the external device;
step 5, constructing a task control model for the external device, wherein the task control model is capable of generating a target control instruction for a next time according to task feedback information, and the task control model is integrated with the correspondence relationship between the neural response data and the control instructions for the external device as constructed in step 4, and is able to obtain a neural response corresponding to the target control instruction according to the correspondence relationship; then, obtaining a stimulation sequence required for the neural response according to the mapping relationship model in step 3; finally, sending the stimulation sequence to the brain-on-a-chip basic module, applying a stimulation to the brain-on-a-chip to cause the brain-on-a-chip to produce an expected neural response, and then converting the neural response into a target control instruction for the external device through the neural signal decoding unit; and
step 6, constructing a reward and punishment control unit, wherein
in addition to being sent to the mapping relationship model, the target control instruction generated by the task control model is also sent to the reward and punishment control unit, and the reward and punishment control unit is capable of receiving the task feedback information sent by the external device; the reward and punishment control unit calculates a completion degree of the target control instruction to perform a task according to the task feedback information, and then generates a reward signal or a punishment signal for the brain-on-a-chip; and the reward signal or the punishment signal is applied to the brain-on-a-chip, so as to train the brain-on-a-chip to produce an accurate neural response according to control needs.

In the above technical solution, in step 1, cortex and hippocampal neurons of 18-day-old embryonic rats are extracted to construct a 2D neuronal network or an artificially cultured, human-brain-like 3D biological tissue culture, that is, a cerebral organ, which is attached to a surface of an MEAs chip for coupling and cultured until matured.

In the above technical solution, step 2 includes the following sub-steps:
step 2.1, selecting candidate stimulation input electrode sites and stimulation response electrode sites:
designing a stimulation sequence composed of bidirectional pulses, and applying a stimulation to every electrode site of the brain-on-a-chip in a random order, wherein during each stimulation, the candidate stimulation input electrode sites are preliminarily selected through two indices: a total number of response electrode sites and a response intensity of remaining electrode sites to the stimulation other than the electrode site to which the stimulation is currently applied;
determining electrode sites whose response intensity is greater than a set threshold corresponding to the candidate stimulation input electrode sites as the candidate stimulation response electrode sites; and
step 2.2, determining final stimulation input electrode sites and stimulation response electrode sites from the candidate stimulation input electrode sites and stimulation response electrode sites:
firstly, determining a number of the final stimulation input electrode sites according to control requirements for the external device; then, selecting a same number of stimulation input electrode sites with a longest distance from each other from the candidate stimulation input electrode sites in step 2.1 as the final stimulation input electrode sites according to the number of the determined final stimulation input electrode sites; then, selecting corresponding stimulation response electrode sites closest to the determined final stimulation input electrode sites as the final stimulation response electrode sites according to the determined final stimulation input electrode sites.

In the above technical solution, step 3 includes the following sub-steps:
step 3.1, firstly collecting a dataset: inputting a stimulation sequence for the final stimulation input electrode sites and stimulation response electrode sites determined in step 2, and meanwhile acquiring and recording real neural response signals of the brain-on-a-chip unit; further processing the neural response signals by a data preprocessing unit to extract effective spike sequence data, and using the obtained spike sequence data as corresponding neural response data of the stimulation sequence; and
step 3.2, training the artificial neural network model using the dataset in step 3.1, so that the model learns an input-output relationship between the stimulation sequence and the neural response, and finally obtaining the mapping relationship model between the stimulation sequence and the neural response.

In the above technical solution, in a construction and training process of the brain-on-a-chip intelligence complex control system, a virtual external device environment is used instead of a real external device, so as to facilitate the development and debugging of the brain-on-a-chip intelligence complex control system, as well as the learning and efficient training of the brain-on-a-chip.

The present invention has the following advantages and beneficial effects.

The present invention adopts not only a 2D brain-on-a-chip, but also a 3D brain-on-a-chip that is closer to a tissue structure and a neural pathway of the human brain, breaks through the limitations of rich cell types and simple network structure in a single brain area cell type, solves the problem of few cell types, and greatly improves the biological intelligence of the brain-on-a-chip.

The present invention constructs the mapping relationship model based on the artificial neural network to assist in regulating the brain-on-a-chip to achieve an expected response, develops an innovative optimization strategy of hybrid intelligence based on an in vitro biological neural network, and generates stimulation parameters that are more suitable for the current activity status of the brain-on-a-chip. The present invention subverts a human intervention and fixed training mode in a current open-loop experiment, breaks through the problem of long-term regulation of expected stable response characteristics of the brain-on-a-chip, and overcomes the problem of poor robustness of a closed-loop control strategy.

The present invention realizes the execution of a control mask of the brain-on-a-chip in a virtual environment and a real external scene with the help of the brain-on-a-chip information interaction and training module, and meanwhile realizes precise closed-loop regulation and training of the brain-on-a-chip in vitro in conjunction with a reward and punishment stimulation mechanism, shortens the training time, and completes the efficient control of external tasks.

### BRIEF DESCRIPTION OF THE DRAWINGS

FIG. 1 is a framework diagram of a brain-on-a-chip intelligence complex control system of the present invention.

FIG. 2 is a schematic diagram of a brain-on-a-chip intelligence complex control system of the present invention connected to a virtual external device environment.

FIG. 3 is a schematic diagram of a virtual external device environment of a robot obstacle avoidance task designed by the present invention.

A person of ordinary skill in the art may still derive other relevant drawings from these accompanying drawings without creative efforts.

### DETAILED DESCRIPTION OF THE EMBODIMENTS

In order to make a person skilled in the art better understand the solutions of the present invention, the technical solution of the present invention will be further described below in conjunction with the specific embodiments.

### Embodiment 1

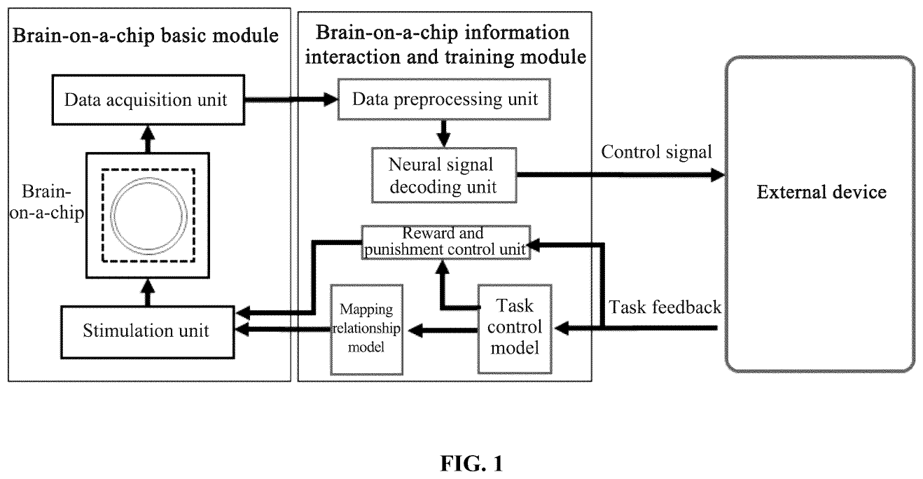

Referring to FIG. 1, a brain-on-a-chip intelligence complex control system includes a brain-on-a-chip basic module and a brain-on-a-chip information interaction and training module.

The brain-on-a-chip basic module includes a brain-on-a-chip, and capable of applying a stimulation to neurons of the brain-on-a-chip and acquiring neural response signals of the brain-on-a-chip, which can realize the stimulation input of the brain-on-a-chip and the neural response output of the brain-on-a-chip.

Specifically, the brain-on-a-chip basic module includes three constituent units: the brain-on-a-chip, a data acquisition unit and a stimulation unit. The brain-on-a-chip is a coupling body of neurons and an MEAs chip, which, specifically, may be a 2D cortex or hippocampal neuronal network and 3D cerebral organ coupled with the MEAs chip, and reaches maturity after culture. The data acquisition unit is configured to read neural response signals of the brain-on-a-chip in real time, which lays the foundation for further signal decoding. The stimulation unit is configured to apply a corresponding voltage stimulation to the neurons of the brain-on-a-chip according to a stimulation sequence of the brain-on-a-chip information interaction and training module.

The brain-on-a-chip information interaction and training module is configured to interact information between the brain-on-a-chip and an external device so as to realize the closed-loop control of the brain-on-a-chip over the external device, and train the brain-on-a-chip to complete a task well in the process of controlling the external device to perform the task. The brain-on-a-chip information interaction and training module includes five parts, i.e., a data preprocessing unit, a neural signal decoding unit, a reward and punishment control unit, a task control model and a mapping relationship model, which are specifically introduced respectively.

The data preprocessing unit is configured to process the acquired original neural response signals of the brain-on-a-chip, eliminate noise and perturbation signal through bandpass filtering, and extract effective spike signals from background noise based on a threshold method.

The neural signal decoding unit is configured to map the preprocessed spike signals linearly or nonlinearly, and convert these signals into control signals recognizable by the external device.

The task control model is used for a control task of the external device, and is capable of generating a target control instruction for a next time according to task feedback information, and the task control model is integrated with a correspondence relationship between the neural response data and control instructions, and is able to obtain a neural response corresponding to the target control instruction according to the correspondence relationship.

The mapping relationship model is configured to construct a mapping relationship between a stimulation sequence of the brain-on-a-chip and the neural response of the brain-on-a-chip.

The reward and punishment control unit is configured to compare a difference between the target control instruction and the task feedback information (i.e., a completion degree of the target control instruction to control the external device to execute a task), to generate a reward signal or a punishment signal to the brain-on-a-chip.

### Embodiment 2

This embodiment introduces a construction and training method of the brain-on-a-chip intelligence complex control system. A working principle and steps of the method are as follows.
Step 1: Make and cultivate a mature brain-on-a-chip.

Cortex and hippocampal neurons of 18-day-old embryonic rats are extracted to construct a 2D neuronal network or an artificially cultured, human-brain-like 3D biological tissue culture, that is a cerebral organ, which is attached to the surface of an MEAs chip for coupling and cultured until matured.
Step 2: Conduct a pre-experiment to determine stimulation input electrode sites and stimulation response electrode sites of the brain-on-a-chip. Specifically, the step 2 further includes the following sub-steps.
Step 2.1: Select candidate stimulation input electrode sites and stimulation response electrode sites.

A stimulation sequence composed of bidirectional pulses (e.g.: 10 pulses of 1 Hz) is designed, and a stimulation is applied to every electrode site of the brain-on-a-chip in a random order, wherein during each stimulation, the candidate stimulation input electrode sites are preliminarily selected through two indices: a total number of response electrode sites and a response intensity of remaining electrode sites to the stimulation other than the electrode site to which the stimulation is currently applied (that is, the higher the response intensity and the greater the number of responding electrode sites, thus the stronger the response will be produced by the electrode site to which this stimulation is applied, so the stimulation input electrode sites whose response intensity meets a set response intensity threshold m and whose number also meets a set number threshold n may also be selected as the candidate stimulation input electrode sites).

A peri stimulus time histogram (PSTH) is an index that quantifies the response intensity of neurons to the stimulation (a higher PSTH value indicates a stronger response of the neurons to an inputted stimulation). The electrode sites having strong response intensity (the response intensity is greater than a set threshold) corresponding to the candidate stimulation input electrode sites are determined as the candidate stimulation response electrode sites according to this index.
Step 2.2: Determine final stimulation input electrode sites and stimulation response electrode sites from the candidate stimulation input electrode sites and stimulation response electrode sites.

Specifically: firstly, a number of the final stimulation input electrode sites is determined according to control requirements for the external device. For example, if the controlled external device is a trolley, a left wheel (i.e., a left wheel motor) and a right wheel (i.e., a right wheel motor) of the trolley need to be controlled to control the steering and travel of the trolley, and then the number of the required final stimulation input electrode sites is 2, which correspondingly control the left wheel and the right wheel respectively. Then, a same number of stimulation input electrode sites with a longest distance from each other are selected from the candidate stimulation input electrode sites in step 2.1 as the final stimulation input electrode sites according to the number of the determined final stimulation input electrode sites. Then, corresponding stimulation response electrode sites closest to the determined final stimulation input electrode sites are selected as the final stimulation response electrode sites according to the determined final stimulation input electrode sites.
Step 3: Obtain a mapping relationship model between a stimulation sequence and a neural response by training.
Step 3.1: Firstly collect a dataset: inputting stimulations to the final stimulation input electrode sites and stimulation response electrode sites determined in step 2, and acquiring neural response signals corresponding to the stimulations, i.e., inputting stimulation sequence data to the brain-on-a-chip unit through a stimulation unit, and meanwhile acquiring and recording real neural response signals of the brain-on-a-chip through a data acquisition unit; further processing these neural response signals by a data preprocessing unit to extract effective spike sequence data; and using the obtained spike sequence data as corresponding neural response data of the stimulation sequence.
Step 3.2: Then, train an artificial neural network model using the above dataset, wherein a single input of the artificial neural network model is a neural response at a certain moment and a stimulation sequence for a period of time, and an output of the artificial neural network model is a predicted neural response for a period of time thereafter; train the model by constructing an objective function to minimize an error between the predicted neural response and a real neural response and adjusting weights in the artificial neural network model, so that the model learns an input-output relationship between the stimulation sequence and the neural response; and finally obtain the mapping relationship model between the stimulation sequence and the neural response.
Step 4: Construct a neural signal decoding unit.

A correspondence relationship between neural response data (i.e., spike sequence data) and control instructions for the external device is constructed based on the neural response data collected in the step 3.1, and the correspondence relationship is embedded into a neural signal decoding unit to enable the neural signal decoding unit to convert (decode) the neural response data into the control instructions for the external device.
Step 5: Construct a task control model for the external device.

The task control model which is suitable for an external device control mask, e.g., a trolley obstacle avoidance task control model, a trolley trajectory tracking task control model, or a manipulator grasping task control model is constructed. The task control model is capable of generating a target control instruction for a next time according to task feedback information, and the task control model is integrated with the correspondence relationship between the neural response data and the control instructions for the external device as constructed in step 4, and is able to obtain a neural response corresponding to the target control instruction according to the correspondence relationship. Then, a stimulation sequence required for this neural response may be obtained according to the mapping relationship model in step 3. Finally, this stimulation sequence is sent to a stimulation unit of the brain-on-a-chip basic module, a stimulation is applied to the brain-on-a-chip to cause the brain-on-a-chip to produce an expected neural response, and then the neural response is converted into a target control instruction for the external device through the neural signal decoding unit.
Step 6: Construct a reward and punishment control unit.

In addition to being sent to the mapping relationship model, the target control instruction generated by the task control model is also sent to the reward and punishment control unit, and the reward and punishment control unit is capable of receiving the task feedback information sent by the external device. Further, the reward and punishment control unit may generate a reward signal or a punishment signal for the brain-on-a-chip (if the completion degree meets a set threshold, a reward signal for the brain-on-a-chip is generated; and if the completion degree is less than the set threshold, a punishment signal for the brain-on-a-chip is generated) by comparing a difference between the target control instruction and the task feedback information (i.e., the target control instruction controls a completion degree of the external device to perform a task). The reward signal or the punishment signal may be applied to the brain-on-a-chip through the stimulation unit, so that the brain-on-a-chip produces an accurate neural response according to control needs.

### Embodiment 3

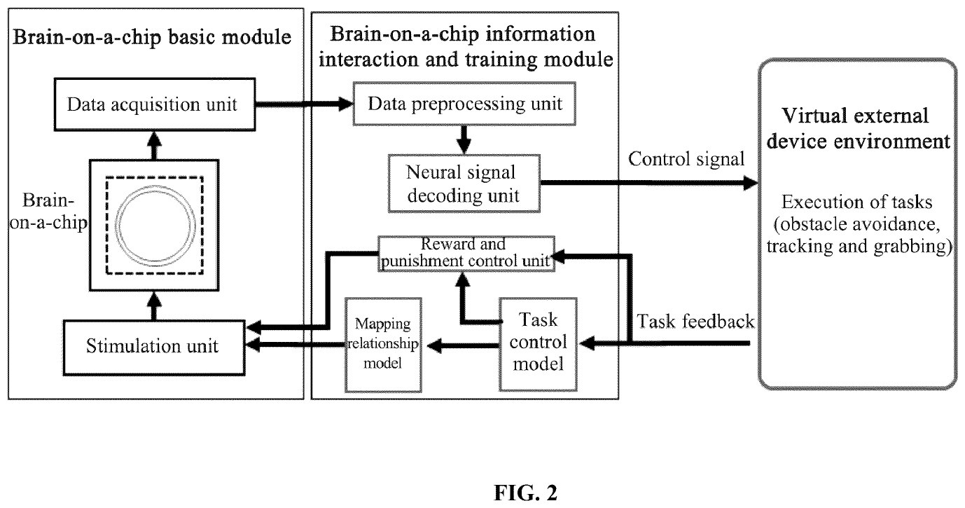

Based on the above embodiments, further, referring to FIG. 2, in a construction and training process of the brain-on-a-chip intelligence complex control system, a virtual external device environment is used instead of a real external device, so as to facilitate the development and debugging of the brain-on-a-chip intelligence complex control system, as well as the learning and efficient training of the brain-on-a-chip.

The necessity of using the virtual external device environment: due to the particularity of electrophysiological activities of the brain-on-a-chip and the limitations of the actual physical environment of the control task, the brain-on-a-chip has the following problems:
1) the brain-on-a-chip has long culture cycle and high cost, is easy to fatigue in the status of long-term stimulation, is highly dependent on the culture environment, and is relatively fragile to cause cell death resulting from improper operations; and
2) there are certain limitations in the physical environment to realize different control tasks: the construction of the real physical environment is time-consuming and laborious; the real physical environment has system noise and error, which is not friendly to the learning and training of neurons; and the accuracy of sensors in the real physical environment is limited by different devices, etc.

Considering the above factors, in order to facilitate the development and debugging of the brain-on-a-chip intelligence complex control system, as well as the learning and training of the brain-on-a-chip, the virtual external device environment is preferred.

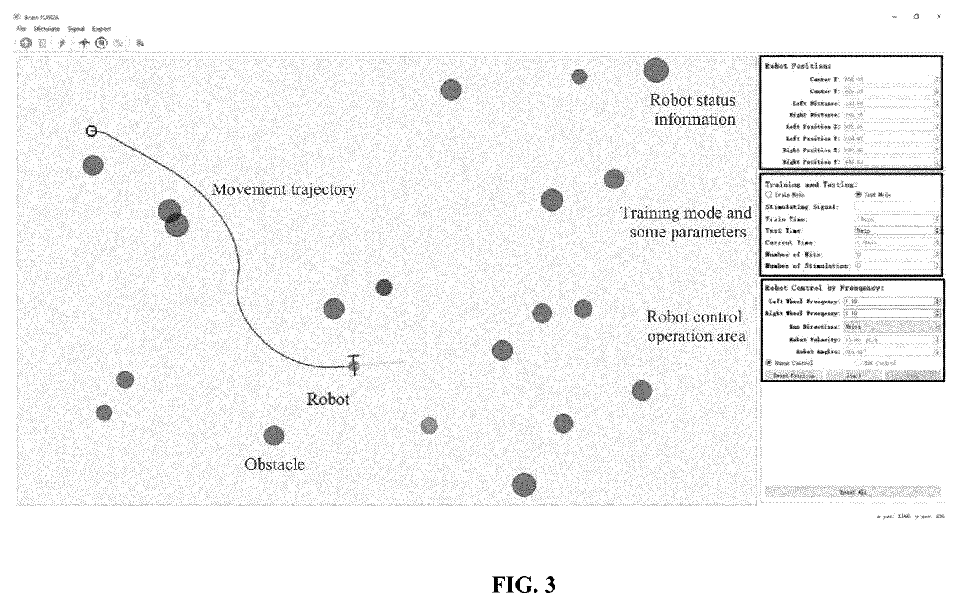

FIG. 3 is a schematic diagram of a virtual external device environment of a robot obstacle avoidance task designed by this embodiment, which mainly includes a virtual robot (i.e., trolley), a visual workspace for an obstacle avoidance task (i.e., a virtual obstacle scene), a robot status information panel, a learning training and control operation area, as well as stimulation signal setting, data recording and exporting modules. In addition, there are three types of obstacle distribution, namely: regular layout, random layout, and artificially defined obstacle layout, respectively. When a robot is moving in the field, signal display and the trajectory synchronization can be performed in real time, and a response deviation curve of the left wheel and the right wheel provides an intuitive and convenient display index for judging an obstacle avoidance status of the robot.

The virtual robot mainly has two movable wheels, namely the left wheel and the right wheel. The robot controls the movement directions of the left wheel and the right wheel through a wheel speed difference of the left and right wheels, and the visual workspace of the obstacle avoidance task is used to visualize an obstacle scene and a robot's motion trajectory. The robot status information panel mainly presents current motion status information of the robot and distance information from the nearest obstacle. The learning training and control operation area is mainly used to set learning parameters and control the learning process of the brain-on-a-chip.

It should be noted that for the above exemplary description of the present invention, any simple deformation, modification or other equivalent replacement made by a person skilled in the art without paying creative work, without departing from the core of the present invention, falls within the protection scope of the present invention.

What is claimed is:

1. A brain-on-a-chip intelligence complex control system, comprising a brain-on-a-chip basic module and a brain-on-a-chip information interaction and training module, wherein
the brain-on-a-chip basic module comprises a brain-on-a-chip, and is capable of applying a stimulation to neurons of the brain-on-a-chip and acquiring neural response signals of the brain-on-a-chip;
the brain-on-a-chip information interaction and training module comprises a data preprocessing unit, a neural signal decoding unit, a reward and punishment control unit, a task control model, and a mapping relationship model;
the data preprocessing unit is configured to process the acquired original neural response signals of the brain-on-a-chip, and extract effective spike signals as neural response data;
the neural signal decoding unit is configured to map the preprocessed neural response data and convert the neural response data into control instructions recognizable by an external device;
the task control model is used for a control task of the external device, and is capable of generating a target control instruction for a next time according to task feedback information, and the task control model is integrated with a correspondence relationship between the neural response data and the control instructions, and is able to obtain a neural response corresponding to the target control instruction according to the correspondence relationship;
the mapping relationship model is configured to construct a mapping relationship between a stimulation sequence of the brain-on-a-chip and the neural response; and
the reward and punishment control unit is configured to calculate a completion degree of the target control instruction to execute a task according to the task feedback information, to generate a reward signal or a punishment signal to the brain-on-a-chip, and apply the signal to the brain-on-a-chip basic module.

2. The brain-on-a-chip intelligence complex control system according to claim 1, wherein the brain-on-a-chip basic module comprises the brain-on-a-chip, a data acquisition unit and a stimulation unit, wherein the brain-on-a-chip is a coupling body of neurons and an MEAs chip; the data acquisition unit is configured to read neural response signals of the brain-on-a-chip in real time; and the stimulation unit is configured to apply a corresponding stimulation to the neurons of the brain-on-a-chip according to the stimulation sequence of the brain-on-a-chip information interaction and training module.

3. A construction and training method of the brain-on-a-chip intelligence complex control system according to claim 1, comprising the following steps:
step 1, making and culturing a mature brain-on-a-chip;
step 2, conducting a pre-experiment to determine stimulation input electrode sites and stimulation response electrode sites of the brain-on-a-chip;
step 3, obtaining a mapping relationship model between a stimulation sequence and a neural response by training;
step 4, constructing a correspondence relationship between neural response data and control instructions for an external device, and embedding the correspondence relationship into a neural signal decoding unit to enable the neural signal decoding unit to convert the neural response data into the control instructions for the external device;
step 5, constructing a task control model for the external device, wherein the task control model is capable of generating a target control instruction for a next time according to task feedback information, and the task control model is integrated with the correspondence relationship between the neural response data and the control instructions for the external device as constructed in step 4, and is able to obtain a neural response corresponding to the target control instruction according to the correspondence relationship; then, obtaining a stimulation sequence required for the neural response according to the mapping relationship model in step 3; finally, sending the stimulation sequence to the brain-on-a-chip basic module, applying a stimulation to the brain-on-a-chip to cause the brain-on-a-chip to produce an expected neural response, and then converting the neural response into a target control instruction for the external device through the neural signal decoding unit; and
step 6, constructing a reward and punishment control unit, wherein in addition to being sent to the mapping relationship model, the target control instruction generated by the task control model is also sent to the reward and punishment control unit, and the reward and punishment control unit is capable of receiving the task feedback information sent by the external device; the reward and punishment control unit calculates a completion degree of the target control instruction to perform a task according to the task feedback information, and then generates a reward signal or a punishment signal for the brain-on-a-chip; and the reward signal or the punishment signal is applied to the brain-on-a-chip, so as to train the brain-on-a-chip to produce an accurate neural response according to control needs.

4. The construction and training method of the brain-on-a-chip intelligence complex control system according to claim 3, wherein in step 1, cortex and hippocampal neurons of 18-day-old embryonic rats are extracted to construct a 2D neuronal network or an artificially cultured, human-brain-like 3D biological tissue culture, that is, a cerebral organ, which is attached to a surface of an MEAs chip for coupling and cultured until matured.

5. The construction and training method of the brain-on-a-chip intelligence complex control system according to claim 3, wherein step 2 comprises the following sub-steps:
step 2.1, selecting candidate stimulation input electrode sites and stimulation response electrode sites:
designing a stimulation sequence composed of bidirectional pulses, and applying a stimulation to every electrode site of the brain-on-a-chip in a random order, wherein during each stimulation, the candidate stimulation input electrode sites are preliminarily selected through two indices: a total number of response electrode sites and a response intensity of remaining electrode sites to the stimulation other than the electrode site to which the stimulation is currently applied;
determining electrode sites whose response intensity is greater than a set threshold corresponding to the candidate stimulation input electrode sites as the candidate stimulation response electrode sites; and
step 2.2, determining final stimulation input electrode sites and stimulation response electrode sites from the candidate stimulation input electrode sites and stimulation response electrode sites:
firstly, determining a number of the final stimulation input electrode sites according to control requirements for the external device; then, selecting a same number of stimulation input electrode sites with a longest distance from each other from the candidate stimulation input electrode sites in step 2.1 as the final stimulation input electrode sites according to the number of the determined final stimulation input electrode sites; then, selecting corresponding stimulation response electrode sites closest to the determined final stimulation input electrode sites as the final stimulation response electrode sites according to the determined final stimulation input electrode sites.

6. The construction and training method of the brain-on-a-chip intelligence complex control system according to claim 3, wherein step 3 comprises the following sub-steps:
step 3.1, firstly collecting a dataset: inputting a stimulation sequence for the final stimulation input electrode sites and stimulation response electrode sites determined in step 2, and meanwhile acquiring and recording real neural response signals of the brain-on-a-chip unit; further processing the neural response signals by a data preprocessing unit to extract effective spike sequence data, and using the obtained spike sequence data as corresponding neural response data of the stimulation sequence; and
step 3.2, training the artificial neural network model using the dataset in step 3.1, so that the model learns an input-output relationship between the stimulation sequence and the neural response, and finally obtaining the mapping relationship model between the stimulation sequence and the neural response.

7. The construction and training method of the brain-on-a-chip intelligence complex control system according to claim 3, wherein a virtual external device environment is adopted in a construction and training process of the brain-on-a-chip intelligence complex control system.
